(19) United States
(12) Patent Application Publication
(10) Pub. No.: US 2013/0100029 A1
(43) Pub. Date: Apr. 25, 2013

(54) METHOD FOR PROVIDING ENGLISH KEYPAD AND MOBILE DEVICE USING THE SAME

(71) Applicant: Sung Yong Moon, Yuseong-gu (KR)

(72) Inventor: Sung Yong Moon, Yuseong-gu (KR)

(21) Appl. No.: 13/807,246

(22) PCT Filed: Jun. 16, 2011
(86) PCT No.: PCT/KR11/04412

§ 371 Date: Dec. 27, 2012

(30) Foreign Application Priority Data
Jun. 29, 2010 (KR) 1020100061688

(51) Int. Cl. G06F 3/0489

(52) U.S. Cl. CPC G06F 3/0489
USPC 345/168; 715/773

(57) ABSTRACT

A method of providing an English letter keypad and a mobile device having the same are provided. The method of providing an English letter keypad of the present disclosure includes generating an English letter keypad, displaying the generated English letter keypad, and receiving an input of a user manipulation using the displayed English letter keypad, and English letters having high use frequencies are placed on the English letter keypad first, and English letters having low use frequencies are placed on the English letter keypad later. By the above, it is possible to significantly reduce the number of typing for inputting English letters, increasing English typing speed and user convenience.

### BACKGROUND OF THE INVENTION

1. Field of the Invention

Methods and apparatuses consistent with the exemplary embodiments relate to an English keypad, and more particularly to a method for providing an English keypad that a user may use to input English letters, and a mobile device using the same.

2. Background Art

It is general to use a QWERTY keypad, when using a PC. However, a QWERTY keypad has too many keys, and is thus not suitable for a small size mobile device.

Not only that, a QWERTY keypad is suitable for mechanical keypads rather than digital keypads, and people use QWERTY solely because they are most used to it.

ABC keypads are most widely used in mobile devices such as smart phones. An ABC keypad is a keypad where 2-3 letters are placed in each key of the keypad in an alphabetical order. It has an advantage that letters are easy to find since the keys are arranged in an alphabetical order.

However, a user has to manipulate a keypad numerous times when using an ABC keypad. In a case of using an ABC keypad, it may be necessary to manipulate the keypad 7 to 10 times even when typing a word made of 3 or 4 letters which are most frequently used in English. That is, using an ABC keypad may be very inefficient.

### SUMMARY OF THE INVENTION

### 1. Technical Problem

The present disclosure has been presented to resolve the aforementioned problems, and the purpose of the present disclosure is to provide a keypad which may significantly reduce the number of times needed for inputting English, and a mobile device using the same.

### 2. Technical Solution

According to an exemplary embodiment of the present disclosure, there is provided a method for providing an English letter keypad, the method including generating an English letter keypad; displaying the generated English letter keypad; and receiving an input of a user manipulation using the displayed English letter keypad, and English letters with high use frequencies are placed on the English letter keypad first, and English letters with low use frequencies are placed on the English letter keypad later.

In addition, it is desirable that English letters with high use frequencies are placed on an upper left side or center of the English letter keypad.

Furthermore, English letters with high use frequencies may be placed on an upper portion of the English letter keypad, and English letters with low use frequencies may be placed on a lower portion of the English keypad.

In addition, it is desirable that consonants are placed on a left side or center of the English letter keypad, and vowels are placed on a right side or center of the English letter keypad.

Furthermore, it is desirable that an English letter which is frequently used as a first letter in an English word is placed on a left side of the English letter keypad.

In addition, it is desirable that an English letter which is frequently used as a second letter in an English word is placed on a center of the English letter keypad.

Furthermore, it is desirable that an English letter is placed close to English letters which are used frequently together, and placed in a key having English letters which are not frequently used together.

In addition, one of the keys provided in the English letter keypad may be a key used to input a command to input once again an English letter which has been input right before.

According to an exemplary embodiment of the present disclosure, there is provided a mobile device which includes a generation unit which generates an English letter keypad; a touch screen which displays an English letter keypad generated by the generation unit; and a control unit which receives an input of a user manipulation using the English letter keypad displayed on the touch screen and processes the user manipulation; and English letters having high use frequencies are placed on the English letter keypad first, and English letters having low use frequencies are placed on the English letter keypad later.

### 3. Advantageous Effect

As aforementioned, according to the present disclosure, the number of times of typing for inputting English letters may be significantly reduced, increasing the English typing speed and providing user convenience.

In addition, since the present disclosure does not increase the number of keys forming a keypad, the sizes of the keys forming the keypad may be realized in sufficient sizes enough to provide user convenience.

Furthermore, the keypad presented in the present disclosure may use the conventional type keypad format, providing convenience in designing and familiarity for users.

### BRIEF DESCRIPTION OF THE DRAWINGS

The above and/or other aspects of the present disclosure will be more apparent by describing certain present disclosure with reference to the accompanying drawings, in which:

FIG. 1 is a graph illustrating a result of research on use frequencies of English letters;

FIG. 2 is a graph illustrating a result of research on use frequencies of English letters used as first letters;

FIGS. 3 and 4 are views provided to explain a process where English letters in English letter group 1 are arranged;

FIGS. 5 and 6 are views provided to explain a process where keys belonging to English letter group 2 are arranged;

FIG. 7 is a view provided to explain a process where keys belonging to English letter group 3 are arranged;

FIG. 8 is a view illustrating a smart phone which displays a keypad consisting of keys where English letters are placed;

FIG. 9 is a view comparing the number of times a user has to manipulate the keys when using a conventional ABC letter keypad to input 60 English with high use frequencies, with the number of times a user has to manipulate the keys when using an English keypad according to an exemplary embodiment of the present disclosure; and

FIG. 10 is a block diagram of a smart phone where a keypad consisting of keys having English letters are applied.

### DETAILED DESCRIPTION

1. The Best Embodiments for the Invention

Certain exemplary embodiments are described in higher detail below with reference to the accompanying drawings.

<1. Preliminary Research for Placing English Letters on Keypad>

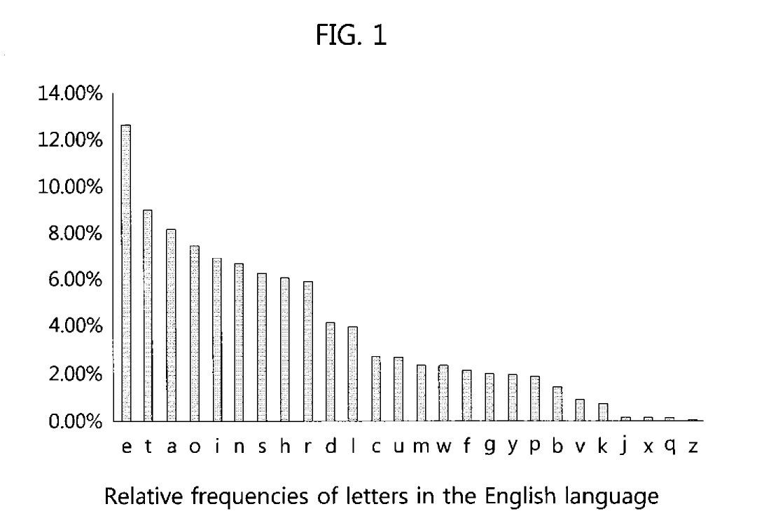

FIG. 1 is a graph illustrating a result of research on use frequencies of English letters. With reference to FIG. 1, it can be seen that the order of use frequencies are as follows: “e”, “t”, “a”, “o”, “I”, . . . , “x”, “q” and “z”.

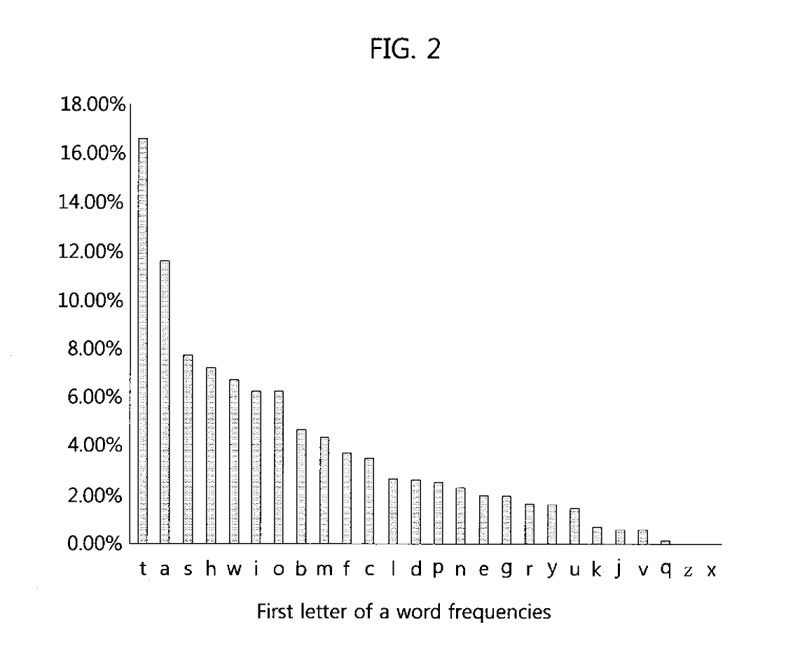

FIG. 2 is a graph illustrating a result of research on use frequencies of English letters used as first letters. With reference to FIG. 2, it can be seen that the order of use frequencies are as follows: “t”, “a”, “s”, “h”, “w”, . . . , “q”, “z”, and “x”.

Hereinafter, there is provided a detailed explanation on a method of arranging English letters on a keypad in an effective method of inputting English, based on the use frequencies of English letters illustrated in FIGS. 1 and 2.

<2. Forming English Letter Groups>

A keypad generally consists of 12 keys. The total number of English letters is 26, which is greater than the number of keys on a keypad. Therefore, it is impossible to place one English key on each key.

Meanwhile, at least one of the 12 keys provided in the keypad may be designated as a special key used to input special commands. In the present embodiment, one of the 12 keys provided in the keypad is designated as a “DOUBLE” key.

A “DOUBLE” key is a key used to input once again a command to input an English letter which has been input right before. The “DOUBLE” key is placed on a lowermost left side of the keypad. This is where “*” key is placed on a keypad for phones.

As such, since one of the 12 keys provided in the keypad is designated as the “DOUBLE” key in the present embodiment, 26 English letters must be arranged in 11 keys.

More specifically, since ‘26=11*2+4’,

1) First, 11 English letters must be placed in each of the 11 keys,

2) And then further 11 English letters must be placed in each of the 11 keys; and

3) 4 English letters must be placed in each of the 4 keys once again.

Accordingly, 3 English letters are placed in each of 4 keys, and 2 English letters are placed in each of 7 keys.

Herein, the 11 English letters ‘first’ placed in each of the 11 keys are called ‘English letter group 1’, the 11 English letters ‘once again’ placed in each of the 11 keys are called ‘English letter group 2’, and the 4 English letters ‘once again’ placed in each of the 4 keys are called ‘English letter group 3’.

English letter groups are formed based on the result of research on use frequencies illustrated in FIG. 1. That is, the 11 English letters with high use frequencies form ‘English letter group 1’; the 11 English letters with the next high use frequencies form ‘English letter group 2’; and the 4 English letters with low use frequencies form ‘English letter group 3’.

Accordingly, 1) “E”, “T”, “A”, “O, “I”, “N”, “S”, “H”, “R”, “D”, and “L” belong to English letter group 1, 2) “C”, “U”, “M”, “W”, “F”, “G”, “Y”, “P”, “B”, “V”, and “K” belong to English letter group 2, and 3) “F′, “X”, “Q”, and “Z” belong to English letter group 3.

Hereinafter, there are provided detailed processes of placing English letters of each English letter group, in each of the 11 keys.

<3. Placing English Letters Belonging to English Letter Group 1>

The keys belonging to English letter group 1 are placed first. These letters which belong to English letter group 1 are English letters with high use frequencies. Therefore, reducing the number of times of key manipulation needed to input these letters is a way to reduce the overall number of times of key manipulation by a user.

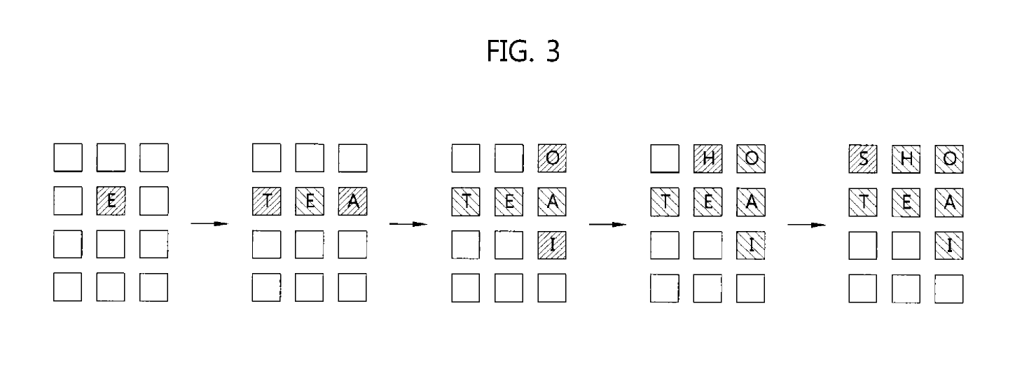

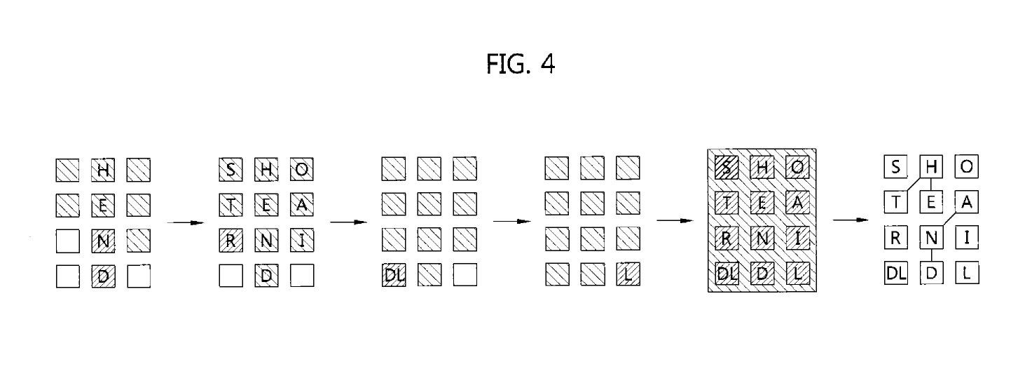

FIGS. 3 and 4 are views illustrating a process of placing English letters belonging to English letter group 1. As aforementioned, English letter group 1 include “E”, “T”, “A”, “O”, “I”, “N”, “S”, “H”, “R”, “D”, and “L”.

First of all, “E” which has the highest use frequency is placed in a center of the keypad. This is to increase the accessibility to other letters, by placing “E”, which is the letter used most frequently, in the center.

Meanwhile, although the location where “E” is placed in FIG. 3 is not an exact center in a mathematically/physical sense, this location shall be dealt as the center of the keypad in this specification for sake of convenience. The location where “5” key is placed in a phone keypad.

Next, “T” and “A” which have the next highest use frequencies following “E” are placed. Herein, “T” which is a consonant is placed on a left side of “E” (the location where “4” key is located in a phone keypad), “A” which is a vowel is placed on a right side of “E”(the location where “6” key is placed in a phone keypad).

A lot of English words start with a consonant rather than a vowel. This is proved by the result of research as in FIG. 2 showing that the possibility that a vowel belonging to English letter group 1 will be used as a first English letter in an English word is 41.051%, whereas the possibility that a consonant belonging to English letter group 1 will be used as a first English letter in an English word is only 26.152%.

As such, there are a lot of English words which start with a consonant rather than a vowel, and thus it is desirable to place consonants in the left side and vowels in the right side.

“T”, “E”, and “A” which have the highest use frequencies are placed in a central portion of the keypad in a horizontal direction which is a location most recognizable to the user and has the highest accessibility. Coincidentally, these letters make the word TEA.

Then, “O” and “I” which have the next highest use frequencies are placed. Since these are both vowels, they are placed on a right side of the keypad.

However, the use frequency of “O” is higher than that of “I”, and thus “O” is placed in an upper portion of “A”(location where “3” key is placed in a phone keypad), and “I” is placed in a lower portion of “A”(location where “9” is placed in a phone keypad).

Meanwhile, as can be seen from “TH”, “WH”, “SH”, and “CH”, the letter “H” which is frequently used as the second letter in English words is placed in an upper center of the keypad (location where “2” is placed in a phone keypad).

In addition, “S”, which is frequently used as the first word in English words following “T” and “A”, is placed in an upper left side of the keypad (location where “1” key is placed in a phone keypad). Accordingly, the vowels frequently used as the first letters of English words are placed in the left side of the keypad.

Next, “N” which has the highest use frequency following “E”, “T”, “A”, “O”, and “I” is placed in a lower central portion of the keypad (location where “8” key is placed in a phone keypad) as illustrated in FIG. 4, and “D” which has a relatively low use frequency in English letter group 1 is placed in a lowermost central portion of the keypad (location where “O” key is placed in a phone keypad).

Coincidentally, the letters arranged vertically in the central portion of the keypad reads HEND, which is an easy-to-read and familiar word.

Meanwhile, “R” which has a low use frequency in English letter group 1 is placed in a lower left portion of the keypad (location where “7” key is placed in a phone keypad).

In addition, the aforementioned “DOUBLE” button is placed in a lowermost left portion (location where “*” key is placed in a phone keypad). As aforementioned, “DOUBLE” key is a key used to repeat a same letter, for example “EE”, “SS” and “OO”.

In addition, “L” which has the lowest use frequency in English letter group 1 is placed in the lowermost right portion of the keypad (location where “#” key is placed in a phone keypad), completing the arrangement of letters belonging to English letter group 1.

With reference to the far right portion in FIG. 4, the letters which form “THE” and “AND” which are English words with very high use frequencies are adjacent to each other, and thus one can assume that a user could input English words more easily and quickly.

<4. Placing English Letters Belonging to English Letter Group 2>

Once the arrangement of English letters belonging to English letter group 1 is completed, the English letters belonging to English letter group 2 are placed in the keypad. In arranging the English letters belonging to English letter group 2, the locations of English letters which are frequently used together is considered along with the use frequencies.

That is, to consider the locations of English letters that are frequently used together means 1) placing a letter close to letters which are frequently used together with the letter, and 2) placing a letter in a key containing letters which are not frequently used together with the letter.

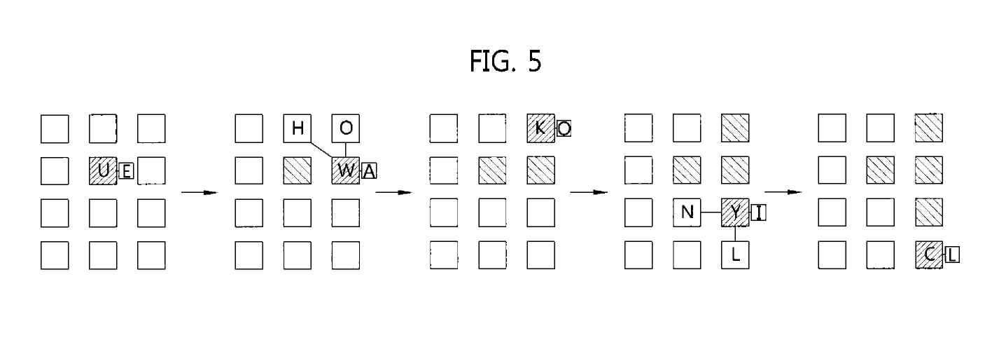

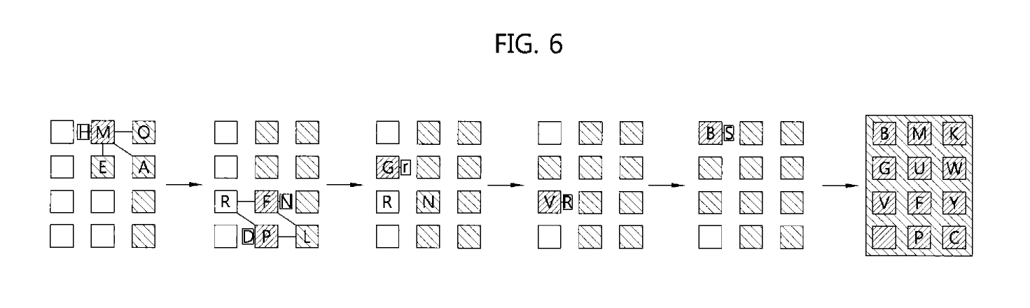

FIGS. 5 and 6 are views explaining a process in which the keys belonging to English letter group 2 are arranged. As aforementioned, English letter group 2 includes “C”, “U”, “M”, “W”, “F”, “G”, “Y”, “P”, “B”, “V”, and “K”.

“U” is a vowel and has the second highest use frequency of among the English letters belonging to English letter group 2. In addition, “U” has a low frequency of being used together with “E” of English letter group 1, of among the English letters belonging to English letter group 2. Therefore, as illustrated in FIG. 5, “U” is placed in a center of the keypad, that is, in a key where “E” of English letter group 1 is placed (location where “5” key is placed in a phone keypad).

“W” has a high use frequency. In addition, as can be seen from “WHERE” and “HOW”, “W” is frequently used together with “H” and “O” which belong to English letter group 1, and “W” is placed in a central right key (location where “6” key is placed in a phone keypad) where “H” and “O” are located nearby.

“K” has the lowest use frequency in English letter group 2, and has a low frequency of being used together with “O” which belongs to English letter group 1. Therefore, “K” is placed in an upper right key (location where “3” key is placed in a phone keypad) which includes “O” of English letter group 1.

“Y” is a consonant acting as a vowel, and has a low frequency of being used together with “1” of English letter group 1. Furthermore, as can be seen from “FUNNY” and “ONLY”. “Y” is frequently used with “N” and “L” belonging to English letter group 1. Therefore, as illustrated in FIG. 5, “Y” is located in a lower right key (location where “9” key is placed in a phone keypad) which includes “I” of English letter group 1 and which has “N” and “L” nearby.

“C” has a low frequency of being used together with “L” of English letter group 1, and thus “C” is placed in a lowermost right key (location where “#” key is placed in a phone keypad) where “L” of English letter group 1 is placed.

“M” has a low frequency of being used together with “H” of English letter group 1. In addition, of among the English letters of English letter group 2, “M” has the highest frequency of being used together with “O”, “E”, and “A” which are vowels belonging to English letter group 1. Therefore, as illustrated in FIG. 6, “M” is placed in an upper central key (location where “2” key is placed in a phone keypad) which includes “H” of English letter group 1, and which has “O”, “E”, and “A” nearby.

“F” and “P” have low frequencies of being used together with “N” and “D” of English letter group 1. In addition, as can be seen from “FROM”, “FLOOR”, “PROCESS” and “PLAN”, “F” and “P” are frequently used with “L” and “R” of English letter group 1.

Therefore, “F” and “P” are placed in a lowermost central key which includes “N” and “D” of English letter group 1, and which has “L” and “R” nearby. Herein, “F” is placed on an upper portion of “P” since it has higher use frequency. That is, “F” is placed in a lower central key (located where “8” key is located in a phone keypad), and “P” is placed in a lowermost central key (located where “O” key is located in a phone keypad.)

“G” has a low frequency of being used together with “T” of English letter group 1. In addition, as can be seen from “-ING”, “-GH” and “GR-” type English words such as “GOING”, “LIGHT” and “GREEN” etc., “G” is frequently used together with “R” and “N” belonging to English letter group 1. Therefore, “G” is placed in a central left key (location where “4” key is placed in a phone keypad) which includes “T” of English letter group 1, and has “R” and “N” nearby.

As can be seen from English words of “BR-”, “PR-” and “TR-” type English words, “R” of English letter group 1 is frequently used with other consonants. On the other hand, “R” of English letter group 1 has a low frequency of being used together with “V” of English letter group 2.

Therefore, “V” which has a low frequency of being used together with “R” is placed in a lower left key which includes “R” of English letter group 1 (location where “7” key is placed in a phone keypad).

“B” has a low frequency of being used together with “S” of English letter group 1. In addition, “B” has a high frequency of being used as a first letter of an English word, and thus it is desirable that “B” is placed on an upper left side of the keypad which is noticeable to the user. Accordingly, “B” is located on an upper left key of the keypad which includes “S” of English letter group 1 (location where “1” key is placed in a phone keypad), completing the arrangement of letters belonging to English letter group 2.

<5. Placing English Letters Belonging to English Letter Group 3>

English letters belonging to English letter group 3 are placed after the arrangement of English letters belonging to English letter group 1 and 2 are completed, that is, at the end. English letters belonging to English letter group 3 are letters with low use frequencies, and thus the number of times of manipulation needed to input these letters are increased.

Especially, the keys belonging to English letter group 3 have low use frequencies, and thus it is desirable to place these keys on a right side of the keypad.

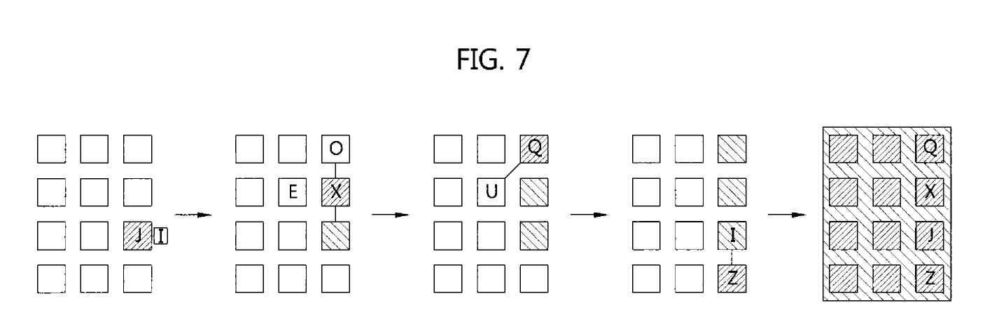

FIG. 7 is a view provided to explain a process in which keys belonging to English letter group 3 are placed. As aforementioned, “J”, “X”, “Q”, and “Z” belong to English letter group 3.

“J” has a low frequency of being used together with “I”, and thus as illustrated in FIG. 7 is placed in a lower right key which includes “I” of English letter group 1 (locations where “9” key is placed in a phone keypad).

In addition, as can be seen from “EXCEL”, “BOX”, “FOX”, and “SIX” etc., “X” is frequently used with “E”, “O” and “I” belonging to English letter group 1. Therefore, “X” is placed in a central right key (location where “6” key is placed in a phone keypad) which has “E”, “O” and “I” of English letter group 1 nearby.

In addition, as can be seen from “QUIET”, “QUIT”, and “QUESTION”, “Q” is frequently used with “U” which belongs to English letter group 1. Therefore, “Q” is placed in an upper right key (location where “3” key is placed in a phone keypad) which has “U” nearby.

Furthermore, as can be seen from. “SIZE” and “QUIZ” etc., “Z” is frequently used with “I” belonging to English letter group 1. Therefore, “Z” is placed in a lowermost right key (location where “#” key is placed in a phone keypad) which has “I” of English letter group 1 nearby, completing the arrangement on the letters belonging to English letter group 3.

<6. Keypad According to the Aforementioned Methods of Placing English Letters>

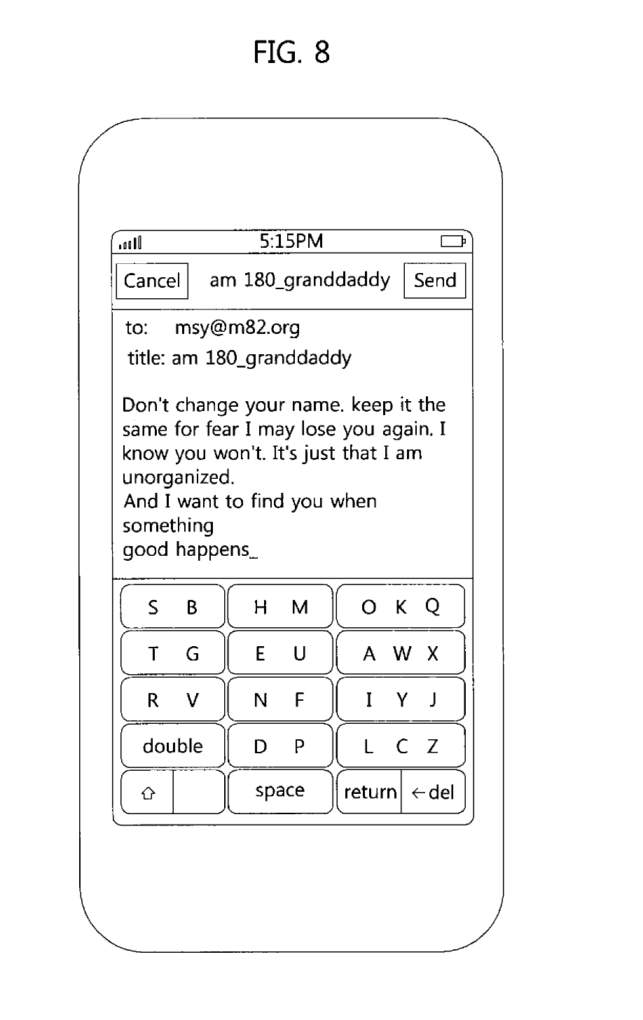

FIG. 8 illustrates a smart phone displaying a keypad consisting of keys in which English letters are placed according to the method of placing English letters explained in “1.” to “5.”.

As illustrated in FIG. 8, a keypad displayed on a smart phone may be used to perform not only writing emails but also doing the internet, writing documents, managing address books and schedules etc.

Meanwhile, in the keypad displayed on the smart phone illustrated in FIG. 8, right side keys are realized to be bigger than left side keys or central keys. This is because 3 English letters are placed in each of the right side keys.

However, this is just an embodiment, and thus the keypad may be realized differently. That is, it is possible to realize a keypad to have same size keys.

<7. Verifying Keypad in the Aforementioned Method of Placing English Letters>

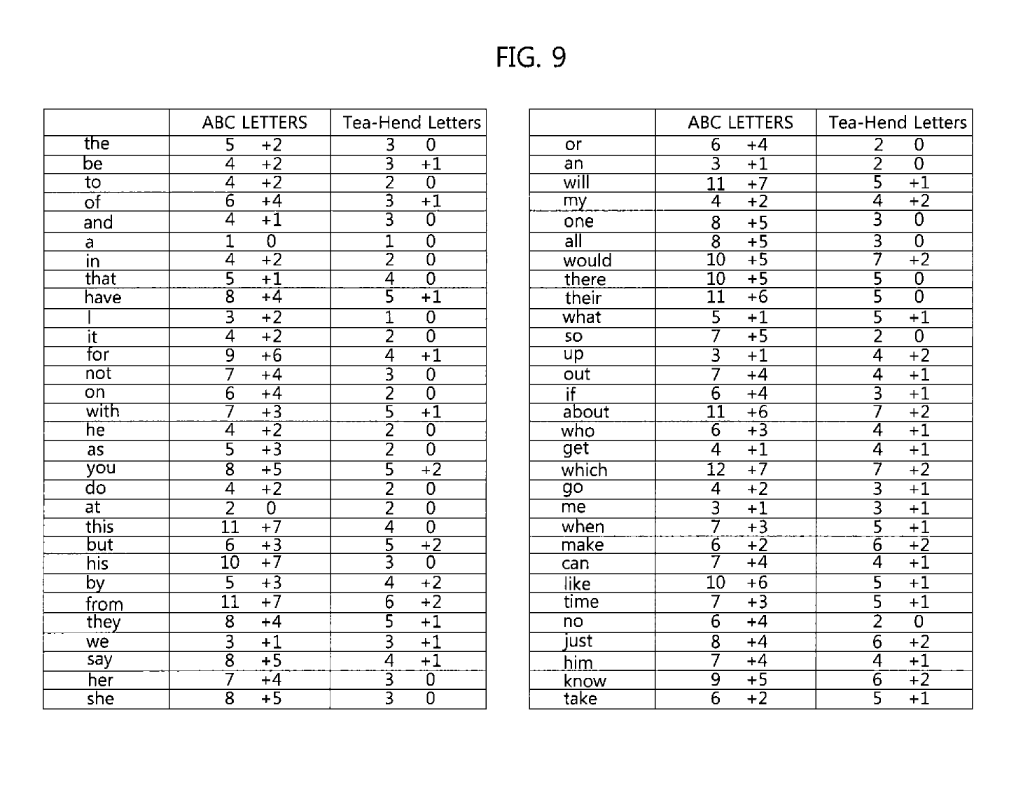

FIG. 9 is a view comparing the number of times a user has to manipulate the keys when using an existing ABC letter keypad to input 60 English with high use frequencies, with the number of times a user has to manipulate the keys when using a letter keypad, according to an exemplary embodiment of the present disclosure.

The keypad according to the present embodiment as in FIG. 9 is referred to as “Tea-Hend letter”, since the English letters placed in the central portion of the keypad in a horizontal direction according to the present embodiment reads “TEA”, and the English letters placed in a vertical direction reads “HEND”.

From the results shown in FIG. 9, one can see that the number of times of manipulation that a user has to make when using the English letter keypad according to the present embodiment is reduced significantly.

<8. Smart Phone Where Keypad According to the Aforementioned English Letter Placing Method is Applied>

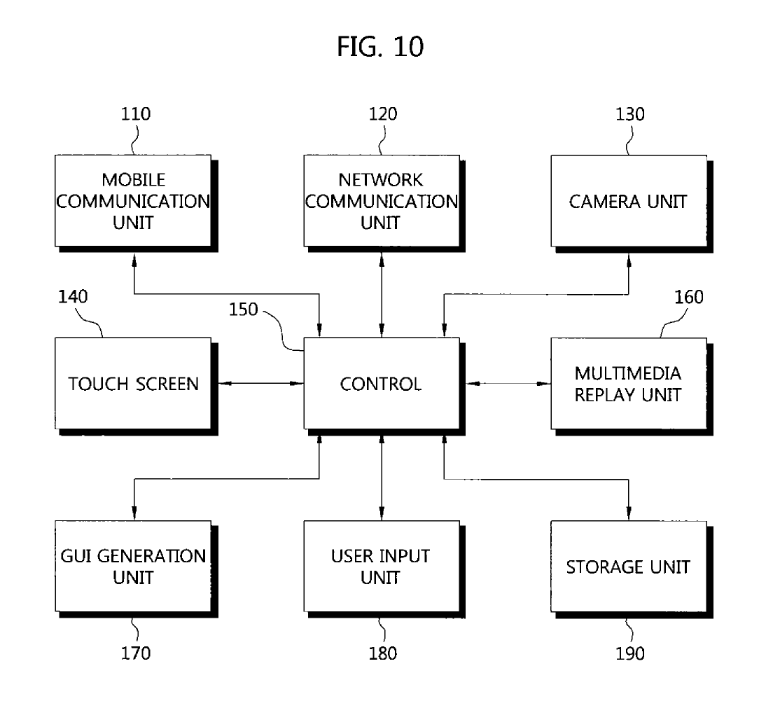

FIG. 10 is a block diagram of a smart phone which applies a keypad consisting of keys having English letters according to the English letter placing method explained through the aforementioned “1.” to “4.”

As illustrated in FIG. 10, a smart phone includes a mobile communication unit 110, network communication unit 120, camera unit 130, touch screen 140, control unit 150, multimedia replay unit 160, GUI generation unit 170, user input unit 180, and storage unit 190.

The mobile communication unit 110 is a module which accesses a mobile communication network and transmits/receives data necessary for mobile communication. The network communication unit 120 is a module which communicates with peripheral devices in wireless network communication methods such as WiFi or Blue tooth. The camera unit 130 is a module which generates photos/video through photographing.

The touch screen 140 performs as a display where information to be provided the user is displayed, but is also a user input means which receives user commands through touching. GUI generation unit 170 generates GUIs used for receiving inputs of user commands, and the aforementioned keypad is a type of GUI.

The multimedia replay unit 160 replays a multimedia file stored in the storage unit 190. The user input unit 180 is a physical button for receiving an input of a user command.

The control unit 150 controls operations of the mobile communication unit 110, network communication unit 120, camera unit 130, touch screen 140, multimedia replay unit 160, GUI generation unit 170, user input unit 180 and storage unit 190, and delivers data to and from the above units.

The keypad generated by the GUI generation unit 170 is displayed on the touch screen by the control unit 150. In addition, the control unit 150 controls other elements forming the smart phone according to a user command input through the keypad displayed on the touch screen 140.

<9. Modified Examples>

Although the keypad in the present embodiment is provided to the user in a GUI format through the touch screen 140, this is an exemplary embodiment for convenience of explanation. Thus, it is possible to provide a keypad having a PUI (Physical User Interface) format through the user input unit 180 and not the keypad touch screen 140. In this case, the keypad is realized as a keypad consisting of physical button type keys.

In addition, the keypad presented above is applicable to devices other than smart phones. Herein, it is a matter of course that the devices other than smart phones could be stationary type devices as well as mobile devices.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for providing an English letter keypad, comprising:
generating an English letter keypad;
displaying the generated English letter keypad; and
receiving an input of a user manipulation using the displayed English letter keypad,
wherein, English letters with high use frequencies are placed on the English letter keypad first, and English letters with low use frequencies are placed on the English letter keypad later.

2. The method according to claim 1, wherein the English letters with high use frequencies are placed on an upper left side or center of the English letter keypad.

3. The method according to claim 1, wherein the English letters with high use frequencies are placed on an upper portion of the English letter keypad, and
English letters with low use frequencies are placed on a lower portion of the English keypad.

4. The method according to claim 1, wherein consonants are placed on a left side or center of the English letter keypad, and
vowels are placed on a right side or center of the English letter keypad.

5. The method according to claim 1, wherein an English letter which is frequently used as a first letter in an English word is placed on a left side of the English letter keypad.

6. The method according to claim 1, wherein an English letter which is frequently used as a second letter in an English word is placed on a center of the English letter keypad.

7. The method according to claim 1, wherein an English letter is placed close to English letters which are used frequently together, and placed in a key having English letters which are not frequently used together.

8. The method according to claim 1, wherein one of the keys provided in the English letter keypad is a key used to input a command to input once again an English letter which has been input right before.

9. A mobile device comprising:
a generation unit which generates an English letter keypad;
a touch screen which displays an English letter keypad generated by the generation unit; and
a control unit which receives an input of a user manipulation using the English letter keypad displayed on the touch screen and processes the user manipulation;
wherein English letters having high use frequencies are placed on the English letter keypad first, and English letters having low use frequencies are placed on the English letter keypad later.
